(19) United States
(12) Patent Application Publication
(10) Pub. No.: US 2006/0163868 A1
(43) Pub. Date: Jul. 27, 2006

(54) Vehicle service tag sheet, system and method for facilitating a vehicle service request

(76) Inventor: David A. Baumann, Manchester, MO (US)

Correspondence Address: HARNESS, DICKEY, & PIERCE, P.L.C, 7700 BONHOMME, STE 400, ST. LOUIS, MO, 63105, US

(21) Appl. No.: 11/036,804

(22) Filed: Jan. 14, 2005

(51) Int. Cl. B42D 15/00

(52) U.S. Cl. 283/66.1

(57) ABSTRACT

A vehicle service tag sheet system for facilitating a vehicle service request generally includes a pad of sheets attached to a backing material of a thickness sufficient to allow a service station attendant to take notes on one of the sheets without placing the pad on a hard surface. In one embodiment, each sheet includes a vehicle identification section that has printed thereon an identification number, and a key identification section that has printed thereon the identification number. Each sheet also includes a services section that has printed thereon the identification number and prompts for reminding the user to take down pertinent information for the vehicle service request.

### FIELD OF THE INVENTION

The present invention generally relates to sheets and methods of using such sheets for facilitating a vehicle service request.

### BACKGROUND OF THE INVENTION

Car, truck and other vehicle owners take their vehicles to service stations when their vehicles break down or for routine services or check-ups. The vehicle owner is interested in making sure that information is conveyed efficiently to the service station attendant so that the vehicle owner is not unreasonably detained, but more importantly the vehicle owner is interested in making sure that its vehicle receives proper attention.

The service stations are interested in efficiently recording the needs and wants of its customers, but are also interested in ensuring the desired transaction is recorded properly and that the correct vehicle is associated with the correct customer and desired repairs and maintenance. The service stations are also interested in providing all potential repairs and maintenance that a customer might need, even if the customer has not remembered to bring all such repairs and maintenance to the attention of the service station attendant. The service stations are interested in an efficient manner of transferring the data from a write up sheet to an electronic repair order system or multiple copy paper repair order system.

### SUMMARY OF THE INVENTION

Aspects of the present invention are directed to a vehicle service tag sheet, system and method for facilitating a vehicle service request. According to one aspect of the present invention, a vehicle service tag sheet generally includes a vehicle identification section that has printed thereon an identification number, and a key identification section that has printed thereon the identification number. The sheet also includes a services section that has printed thereon the identification number and prompts to remind the user to take down pertinent information for the vehicle service request. In one exemplary embodiment, the sections can be separated by perforations between all sections to facilitate separating the sections.

In various embodiments, the prompts for pertinent information can include prompts for vehicle identification information, prompts for vehicle repair information, prompts for add-on services and prompts for additional notes. In further embodiments, the prompt for additional notes is on a side of the sheet opposite the prompts for vehicle repair information. The back side of the sheet can also be used for advertisement purposes that can be individualized for each service facility during production.

In another aspect of the present invention, a vehicle service tag sheet system generally includes a pad of sheets attached to a backing material of a thickness sufficient to allow a service station attendant to take notes on one of the sheets without placing the pad on a hard surface. The sheets can include a vehicle identification section that has printed thereon an identification number, a key identification section that has printed thereon the identification number, and a services section that has printed thereon the identification number, prompts for customer identification information, and prompts for vehicle repair information.

In yet another aspect, the invention provides a method of using the above product by service stations to take down an order, offer additional add-on services, and track the progress of the service in a notes section. To this end, a backing can support a pad of sheets so that the pad serves as a clipboard, but provides features to process and track the order, including the key tag, the rearview mirror identification number tag, and the area for recording the order.

Further aspects and areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective front view of a pad of sheets according to one exemplary embodiment of the present invention;

FIG. 2 is a plan view of a front of a sheet according to one exemplary embodiment of the present invention; and

FIG. 3 is a plan view of a back of a sheet according to one exemplary embodiment of the present invention.

Corresponding reference numerals indicate corresponding features throughout the several views of the drawings.

### DETAILED DESCRIPTION OF THE EXEMPLARY EMBODIMENTS

The following description of the exemplary embodiments is merely exemplary in nature and is in no way intended to limit the invention, its application, or uses.

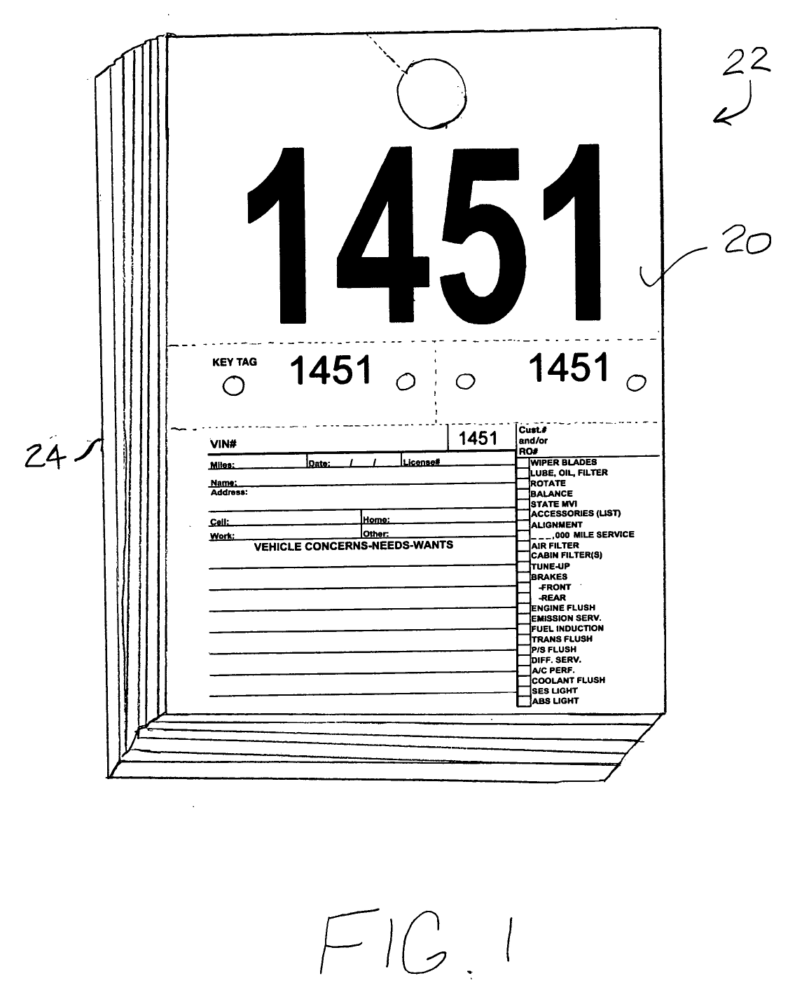

FIG. 1 illustrates a vehicle service tag sheet 20 that is included in a pad 22 of sheets according to one embodiment of the invention. As shown in FIG. 1, the sheets are attached to a backing material 24. This backing material 24 preferably has sufficient thickness or rigidity to allow a service station attendant to take notes on one of the sheets 20 without placing the pad 22 on a hard surface. In one embodiment, the backing material 24 is made of cardboard, although other suitable materials can also be used.

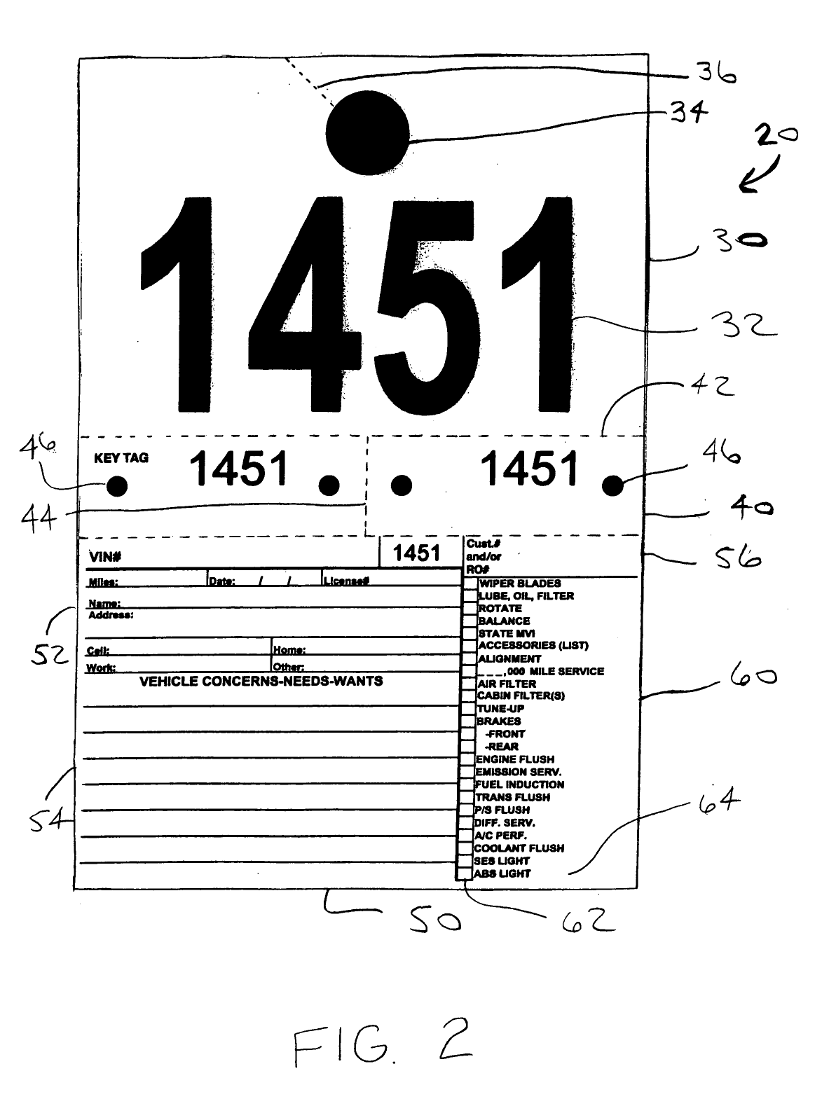

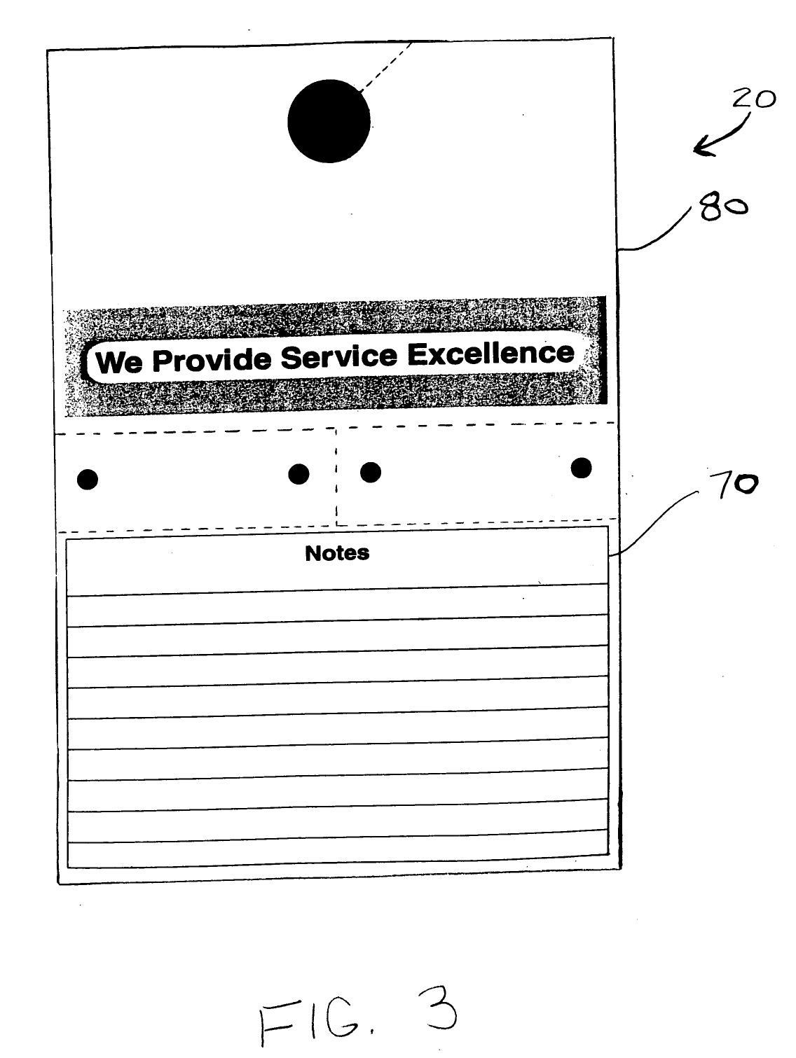

FIG. 2 shows a front side of a sheet 20, and FIG. 3 shows a backside of sheet 20. As depicted in FIG. 2, the sheet 20 comprises several sections. A top section is shown as the vehicle identification section 30 that has an identification number 32 printed thereon. The sheets 20 included within pad 22 are all identical, except that each sheet will bear a different identification number 32 and preferably, each sequential sheet will bear a sequential number. For example, the top sheet might bear identification number 1 and the second sheet would be identification number 2. As shown in FIGS. 1 and 2, the identification number is “1451”. In which case, the next sheet included within the pad would bear the identification number “1452”. The identification number could be shortened or lengthened depending, for example, on the needs of the particular service station with specific emphasis on tying the number into the computer system of the service station. In addition, other alphanumeric characters (e.g., numbers, letters, combinations thereof, etc.), symbols, roman numerals, languages, etc. could additionally or alternatively be used for the identification number depending, for example, on the needs of the particular service station.

The vehicle identification section 30 has an open portion 34 that is adapted to allow the vehicle identification section 30 to be hung from a vehicle rearview mirror to visually display the identification number 32. The open portion 34 is shown as a circle cut-out with a perforation line 36 to allow the section 30 to be hung on the bar that connects the rear view mirror to the car. The identification number 32 is sized large enough to allow its easy viewing when hung from the rear view mirror. Alternatively, other suitable shapes can be used for the open portion 34 besides circular and/or other means for allowing the vehicle identification section 30 to be hung from a vehicle review mirror can be used.

The vehicle service tag sheet 20 also comprises a middle section that is a key identification section 40. In the illustrated embodiment, the key identification section 40 is separated from the vehicle identification section 30 by a perforation line 42. The key identification section 40 includes the same identification number as vehicle identification section 30 for a particular sheet 20. In the illustrated embodiment, the key identification section 40 includes two at least substantially identically sized sections (as shown they are identical) that are separated by a perforation line 44.

When the key identification section 40 is removed from the sheet along its perforated lines, the two identical sections can be folded over to form a key tag that is thicker to make it more durable. The key identification section also includes, in a preferred embodiment, opposed openings 46 that match-up when the two sections are folded over to form the key tag. The openings are adapted to be slid on to a key ring or to be attached to a key opening by a wire, string or the like. The key identification section 40 can also include a title printed thereon of “key tag” to facilitate its use by service station attendants. The tags are identically sized so that when folded over the holes 46 line up near the folded edge, which is now a single edge and facilitates easy insertion of the key tag on to the key ring. Alternatively, one side can be attached to the key or key ring and the other side can be provided to the customer as a claim check.

The vehicle service tag sheet 20 also comprises a bottom section that is a services section 50 that has printed thereon the identification number 32 and written prompts to remind the user/service station attendant to obtain pertinent information for the vehicle service request. In the illustrated embodiment, the services section 50 generally includes a customer identification section 52 having prompts for customer identification information, and a vehicle repair information section 54 having prompts for vehicle repair or maintenance information that a customer seeks.

The identification number is the same as on the sections 30 and 40. The identification number assists in tracking of the vehicle and work in progress by making a “report card” for each vehicle being serviced. It can also be utilized by the service attendant for quick reference to each repair job and/or attached to the back of the request order either prior to, during, or after work is completed on the vehicle.

The customer identification section 52 can include some or all of the following information: vehicle VIN number; vehicles miles from the odometer; date of the transaction; license plate number; name of the customer; address of the customer; phone numbers for the customer, including home, work and cell phone; and “other” which could be used for another phone number or an email address. A customer number or request number can also be provided as shown generally at 56.

The vehicle repair information section 54 can include any prompts that are intended to show the repairs that the customer seeks. In the illustrated embodiment, the title “Vehicle Concerns-Needs-Wants” is used. This title is intended to encourage the service station attendant to ask what concerns that vehicle owner has with its vehicle, e.g., the brakes squeak. The customer should thereafter be asked what repairs or maintenance the customer believes its vehicle needs. Finally, the service station attendant should ask the customer if the customer wants any further repairs or maintenance. While there may be things that the vehicle needs, there may be additional repairs or maintenance that, while not necessary, are desired by the customer. While the exact order of asking about “concerns, needs, and wants” may vary, in a preferred embodiment, the order should follow as depicted in FIG. 1, i.e., “concerns” first, followed by “needs” and followed by “wants.” This order is believed to be best received by customers and more likely to lead to the customer requesting repairs that it wants but that are not necessarily needed.

With continued reference to FIG. 2, the services section 50 further includes an add-on services checklist generally shown at 60. The list shown is only exemplary. It reflects fairly routine or more common repairs or maintenance that the customer often times forgets to request because it has forgotten about a particular concern. For example, it is common for customers to be out on a rainy day and realize that its windshield wipers should be replaced, but when it comes time to seek service on the vehicle, the customer forgets this repair. In use, a service station attendant could ask the customer about each item on the list or could have the customer quickly scan the list to determine whether further repairs or maintenance are desired. In the illustrated embodiment, the add-on services checklist 60 includes a written itemized list of add-on services. Other embodiments can additionally, or alternatively, include graphic representations (e.g., pictorial representations, symbols, icons, etc.) of the various services listed in the add-on services checklist.

In a further embodiment, the add-on services checklist 60 can be tied back into a computer system by customer identification number or request order number to remind the customer that a particular service is overdue, e.g., wheel rotation or oil change. Boxes 62 can be provided next to each potential add-on service so that a check mark can be placed in the box to ensure proper tracking and fulfillment of the order. Further, a sufficiently sized blank space is also provided, e.g. at numeral 64, next to each service so that a quoted price can be printed thereon by the service station attendant at the time of taking the order.

Services section 50 can include prompts for a notes section generally referred to 70. As shown in FIG. 3, the notes section 70 is located on the backside of services section 50. This location allows more space for any note taking that may be desired or necessary by the service station attendant. This section 70 can be used to take down further details regarding the requested services or symptoms of the problem. This section 70 could also be used by the service station attendant to track the progress of the repairs or make other similar notes about the repairs, e.g., parts needed to fix the problem. While the notes section 70 could also be located on the front side of services section 50, having the notes section 70 on the backside provides more ample space for writing and to allow the pad 22 to be a smaller size.

Also, one or more prompts could be used for notes section 70 if more specific prompts are desired. The word “prompts” as used for the notes section 70 is defined to include one or more prompts. As shown in FIG. 2, only one prompt, i.e., “Notes” is used with corresponding lines to facilitate note taking.

In a further embodiment, a section is provided regarding information about the service station. As shown in FIG. 3, the section, generally designated 80, is shown on the backside of the vehicle identification section 30, but it could be on the backside of any section or be its own separate section separated by perforations and handed to the customer at the time service or maintenance is requested. As shown, the information is merely a promotional line, “We Provide Service Excellence.” It could, however, provide contact information about the service station, slogans, or other marketing or helpful information.

FIGS. 1 through 3 illustrate a particular embodiment of a sheet 20 that includes certain sections (e.g., 30, 40, 50, 52, 54, 60, 70). Alternatively, other embodiments can include different combinations of one or more (but not necessarily all) of the sections shown for the sheet 20.

Further embodiments can also include one or more of these sections in different locations on the sheet than that shown in the figures. For example, the vehicle identification section 30 can instead be located at the middle or bottom section. Or, for example, the key identification section 40 can instead be located at the top or bottom section. As yet another example, the services section 50 can instead be located at the top or middle section.

In addition, the pad 22 may include any suitable number of sheets depending, for example, on the needs of the particular service station. In addition, the particular size, color, shape, and material of the sheets 20, pad 22, backing material 24, and/or various sheet sections (e.g., 30, 40, 50, 52, 54, 60, 70, etc.) may also vary depending, for example, on the needs of the particular service station. For example, a service station may want to use a certain color of sheets so as to color-coordinate with a logo, trademark, or motif of the service station. As yet another example, some service stations may want to use larger sheets with larger type size to make it easier for the service attendant or customer to read what is on the sheet.

In an exemplary implementation, a method of using the above described invention is also provided. In use, a customer goes to a service station and meets a service station attendant or consultant. The attendant can either at the beginning of the session or the end take down customer and vehicle identification information in section 52. Or, if the information is already in the computer system, the attendant could take down a last name or social security number that will allow customer and vehicle information to be ascertained without taking down all of the information each visit.

Then, using one of the embodiments described, the attendant can first ask the customer what concerns the customer has regarding the vehicle. The concerns can be translated by the attendant into a specific repair or service with the consultation of the customer. The attendant can then ask the customer what the customer wants serviced, which may lead to further repairs or servicing that do not necessarily fall into the “concerns” category. Next, the attendant can ask the customer whether there is anything that the customer wants, which again may lead to further requests that do not fall into the first categories, e.g., the customer may want new rims for the car or other upgrades. The attendant can record this information section 54 or in the notes section 70 if the list is too long for section 54.

Finally, the attendant can ask the customer about some or all of the add-on services identified in add-on services section 60 or the attendant can simply show the customer the list to quickly review. For example, going over the list or having the customer review the list may trigger a reminder that windshield wipers need to be replaced or that it is time to change the oil. The attendant can place a checkmark next to the requested add-on services and record a quoted price in the margin to the right of the service or product description. If desired, the service station could place the form in a stack to be entered into a computer system if electronic tracking is desired.

With the repair and service information completed, the vehicle identification section can be separated at the perforations and hung from the rear view mirror of the vehicle. The key identification section can also be separated at the perforations, folded and attached to the key ring, or half of the key identification section can be attached to the key ring and the other half given to the customer.

Accordingly, various aspects of this invention advantageously combine a note pad, a scrap of paper, or whatever is used to record data for transfer to the computer and the service tag control number/key tag in to one form. Accordingly, it helps insure when the service attendant approaches the customer for service consultation and check-in, the attendant always has something to take notes and record data and further has prompts to remind the attendant about add-on services.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle service tag sheet for facilitating a vehicle service request comprising a vehicle identification section that has printed thereon an identification number, a key identification section that has printed thereon the identification number, and a services section that has printed thereon the identification number and prompts for pertinent information to remind the user to obtain pertinent information for the vehicle service request.

2. The vehicle service tag sheet of claim 1, wherein the sheet has perforations between all sections to facilitate separating the sections.

3. The vehicle service tag sheet of claim 2, wherein the sheet has an open portion that is adapted to allow the vehicle identification section to be hung from a vehicle review mirror to visually display the identification number.

4. The vehicle service tag sheet of claim 1, wherein the key identification section comprises two at least substantially identically sized sections that are adapted to be folded together to form a thicker key identification section.

5. The vehicle service tag sheet of claim 4, wherein the two at least substantially identically sized sections include opposed openings that align when folded together, the openings being adapted to attach to at least one of a vehicle key and a vehicle key chain.

6. The vehicle service tag sheet of claim 1, wherein the prompts for pertinent information comprise prompts for customer identification information and prompts for vehicle repair information.

7. The vehicle service tag sheet of claim 6, wherein the prompts for pertinent information further comprise prompts for add-on services.

8. The vehicle service tag sheet of claim 7, wherein the prompts for pertinent information further comprise prompts for additional notes.

9. The vehicle service tag sheet of claim 8, wherein the prompts for pertinent information further comprise a prompt for customer vehicle concerns, customer vehicle needs, and customer vehicle wants.

10. The vehicle service tag sheet of claim 6, further comprising a section to print information about a vehicle service station that uses the vehicle service tag sheet.

11. A vehicle service tag sheet system for facilitating a vehicle service request comprising a pad of sheets attached to a backing material of a thickness sufficient to allow a service station attendant to take notes on one of the sheets without placing the pad on a hard surface, the sheets comprising a vehicle identification section that has printed thereon an identification number, a key identification section that has printed thereon the identification number, and a services section that has printed thereon the identification number, prompts for customer identification information, and prompts for vehicle repair information.

12. The vehicle service tag sheet system of claim 11, wherein the prompts further comprise prompts for add-on services.

13. The vehicle service tag sheet system of claim 12, wherein the prompts further comprise prompts for notes relating to the vehicle service request.

14. The vehicle service tag sheet system of claim 13, wherein the prompts for notes are on a side of the sheet opposite the prompts for vehicle repair information.

15. The vehicle service tag sheet system of claim 11, wherein the prompts further comprise a prompt for at least one of a customer identification number and a request order number.

16. A vehicle service tag sheet system for facilitating a vehicle service request comprising a pad of sheets attached to a backing material configured to allow a service station attendant to take notes on one of the sheets without placing the pad on a hard surface, the sheets comprising a vehicle identification section that has printed thereon an identification number, a key identification section that has printed thereon the identification number, and a services section that has printed thereon the identification number, prompts for customer identification information, prompts for vehicle repair information, and prompts for add-on services.

17. The vehicle service tag sheet system of claim 16, wherein the identification number on the vehicle identification section is printed in larger type than the identification number on the key identification section.

18. The vehicle service tag sheet system of claim 17, wherein the vehicle identification section is located at a top portion of the sheets, the key identification section is located at a middle portion of the sheets, and the services section is located at a bottom section of the sheets.

19. The vehicle service tag sheet system of claim 18, wherein the prompts further comprise prompts for notes relating to the vehicle service request.

20. The vehicle service tag sheet system of claim 19, wherein the prompts for notes are on a side of the sheet opposite the prompts for the vehicle repair information.
